(19) United States
(12) Patent Application Publication
(10) Pub. No.: US 2012/0021353 A1
(43) Pub. Date: Jan. 26, 2012

(54) METHOD FOR PRODUCING TONER

(75) Inventors: Hiroshi NAGASAWA, Tokyo (JP); Mikio KOUYAMA, Tokyo (JP); Kenji HAYASHI, Tokyo (JP); Hiroaki OBATA, Tokyo (JP)

(73) Assignee: KONICA MINOLTA BUSINESS TECHNOLOGIES, INC., Tokyo (JP)

(21) Appl. No.: 13/185,864

(22) Filed: Jul. 19, 2011

(30) Foreign Application Priority Data
Jul. 20, 2010 (JP) 2010-162723

(51) Int. Cl. G03G 9/087

(52) U.S. Cl. 430/137.15

(57) ABSTRACT

Disclosed is a method for producing toner, comprising (1) mixing, with an aqueous medium, a resin solution of an organic solvent in which amorphous polyester resin having unsaturated dicarboxylic acid monomer units is dissolved, and forming an amorphous polyester resin particle dispersion; (2) adding a radical polymerization initiator to the amorphous polyester resin particle dispersion obtained in (1), cross-linking the amorphous polyester resin, and forming a cross-linked amorphous polyester resin particle dispersion; and (3) mixing at least the cross-linked amorphous polyester resin particle dispersion obtained in (2), with a crystalline polyester resin particle dispersion, aggregating cross-linked amorphous polyester resin particles and crystalline polyester resin particles, and forming toner particles.

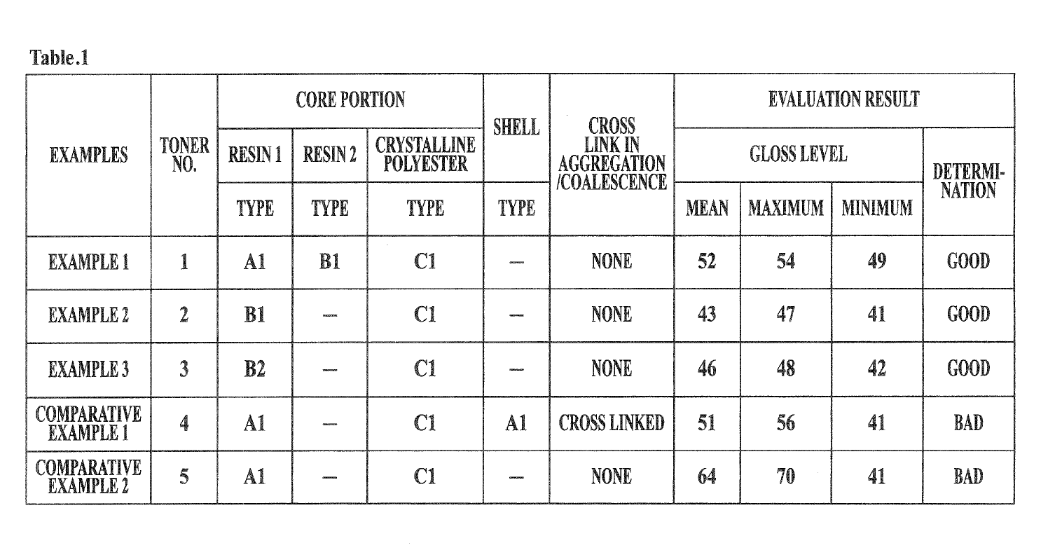

### BACKGROUND OF THE INVENTION

1. Field of the Invention

The present invention relates to a method for producing toner.

2. Description of the Related Art

In recent years, in an electrophotographic image forming apparatus, low-temperature fixing of toner has been progressed from a viewpoint of saving energy. Moreover, due to speed enhancement of a color electrophotographic image forming apparatus, such image forming apparatus has made a remarkable advance into the commercial market of the color printing.

As the low-temperature fixing of the toner became more progressed as described above, it also became possible to obtain high image gloss (for example, refer to Japanese Patent Laid-Open Publication No. 2006-154816).

However, with the progress of the low-temperature fixing, there also occurs a case where the image gloss is desired to be suppressed so as not to become excessive. For example, Japanese Patent Laid-Open Publication No. 2010-55092 discloses a technology for suppressing the gloss.

Japanese Patent Laid-Open Publication No. 2010-55092 described above relates to a method for producing toner that contains cross-linked resin by adding thereto a water-soluble radical polymerization initiator in aggregating particles of respective raw materials of the toner, which are finely dispersed in an aqueous medium.

In such an aggregation as described above, resin on a portion of an outer shell of the toner is cross-linked. Accordingly, a contact area between the water-soluble polymerization initiator and toner (intermediate body) particles is small, and an influence of the water-soluble radical polymerization initiator is weakened. Therefore, there is a problem that the gloss depends on production lots and is not stabilized.

### SUMMARY OF THE INVENTION

The present invention is made in consideration of the above-described circumstances. It is an object of the present invention to provide a method for producing toner, which is capable of stably producing the toner by stabilizing cross-linking of polyester resin particles and suppressing variability of a gloss level of the toner depending on such production lots.

An aspect of the present invention is a method for producing toner, comprising the following (1) to (3) of:

(1) mixing, with an aqueous medium, a resin solution of an organic solvent in which amorphous polyester resin having unsaturated dicarboxylic acid monomer units is dissolved, and forming an amorphous polyester resin particle dispersion;

(2) adding a radical polymerization initiator to the amorphous polyester resin particle dispersion obtained in (1), cross-linking the amorphous polyester resin, and forming a cross-linked amorphous polyester resin particle dispersion; and

(3) mixing at least the cross-linked amorphous polyester resin particle dispersion obtained in (2), with a crystalline polyester resin particle dispersion, aggregating cross-linked amorphous polyester resin particles and crystalline polyester resin particles, and forming toner particles.

### BRIEF DESCRIPTION OF THE DRAWINGS

The present invention will become more fully understood from the detailed description given hereinbelow and the appended drawing, and thus are not intended as a definition of the limits of the present invention, wherein;

Table 1 shows evaluation results of Examples.

### DESCRIPTION OF PREFERRED EMBODIMENT

A description is made below of a method for producing toner according to the present invention.

The method for producing toner according to the present invention includes the following (1) to (3) of:

(1) mixing, with an aqueous medium, a resin solution of an organic solvent in which amorphous polyester resin having unsaturated dicarboxylic acid monomer units is dissolved, and forming an amorphous polyester resin particle dispersion;

(2) adding a radical polymerization initiator to the amorphous polyester resin particle dispersion obtained in (1), cross-linking the amorphous polyester resin, and forming a cross-linked amorphous polyester resin particle dispersion; and

(3) mixing at least the cross-linked amorphous polyester resin particle dispersion obtained in (2), with a crystalline polyester resin particle dispersion, aggregating cross-linked amorphous polyester resin particles and crystalline polyester resin particles, and forming toner particles.

For producing a toner, an amorphous polyester resin, a crystalline polyester resin, a radical polymerization initiator, and colorant are used. Furthermore, a releasing agent, an external additive and the like are used when needed. A description is made below of these.

### <Amorphous Polyester Resin>

A toner according to the present invention contains an amorphous polyester resin as binder resin. By the toner containing the amorphous polyester resin, dispersibility of the colorant in the toner particles and filming resistance of the toner may be enhanced. Note that the “amorphous” polyester resin refers to a polyester resin that does not have an endothermic peak in the curve of differential scanning calorimetry (DSC).

The amorphous polyester resin for use in the toner according to the present invention is not particularly limited and polyester resin known in public can be used as long as amorphous properties are inherent therein.

For example, the amorphous polyester resin can be synthesized by a reaction of publicly known multivalent carboxylic acid with publicly known multivalent alcohol. Commercially available amorphous polyester resin or amorphous polyester resin synthesized can be used appropriately.

As such a multivalent alcohol component that composes the amorphous polyester resin, for example, there are mentioned divalent alcohols such as ethylene glycol, propylene glycol, 1,4-butanediol, 2,3-butanediol, diethylene glycol, triethylene glycol, 1,5-pentanediol, 1,6-hexanediol, neopentyl glycol, 1,4-cyclohexanedimethanol, dipropylene glycol, polyethylene glycol, polypropylene glycol, bisphenol A, and hydrogen-added bisphenol A. Moreover, as trivalent or more multivalent alcohols, for example, there are mentioned glycerin, sorbitol, 1,4-sorbitan, and trimethylol propane.

As such a multivalent carboxylic acid component that composes the amorphous polyester resin, there are mentioned aliphatic dicarboxylic acid and aromatic dicarboxylic acid. As the aliphatic dicarboxylic acid, for example, there are mentioned oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid. As the aromatic dicarboxylic acid, for example, there are mentioned phthalic acid, isophthalic acid, terephthalic acid, naphthalene-2,6-dicarboxylic acid, malonic acid, and mesaconic acid. Moreover, derivatives such as dibasic acid salts, acid anhydrides and lower alkyl esters of these dicarboxylic acids may be used.

Note that, as the unsaturated carboxylic acid monomer units in the above (1), fumaric acid, maleic acid and itaconic acid are preferable since cross-linking reactivity of each thereof is high. Among them, fumaric acid is particularly preferable.

However, preferably, in order to control a degree of cross-linking, a usage amount of the unsaturated carboxylic monomer units is set within a range of 1 mass % or more to 10 mass % or less in the whole of acid monomer units which compose the polyester resin. If the usage amount is less than 1 mass %, then effects of the present invention are less likely to appear, and if the usage amount is larger than 10 mass %, then it is apprehended that productivity may be decreased by excessive cross-linking.

Trivalent or more multivalent carboxylic acid can be used in a range where the polyester resin becomes soluble in the organic solvent in the above-described (1). As the trivalent or more multivalent carboxylic acid, there are mentioned 1,2,4-benzenetricarboxylic acid, 1,2,5-benzenetricarboxylic acid, 1,2,4-naphthalenetricarboxylic acid, and acid anhydrides thereof and lower alkyl esters thereof. These may be used singly, or two or more thereof may be used in combination.

With containing the trivalent or more multivalent carboxylic acid, polymer chains can have a cross-linking structure, and can improve toner offset resistance. However, it is apprehended that an occurrence of an insoluble content may decrease the productivity. Therefore, preferably, the trivalent or more multivalent carboxylic monomer may be set at 10 mass % of the whole of acid monomers for use in the amorphous polyester.

More preferably, linear polyester that does not contain the trivalent or more multivalent carboxylic acid is used as the amorphous polyester. Preferably, elasticity impartation when the toner is fused is achieved by adding the radical polymerization initiator and cross-linking the amorphous polyester resin.

Moreover, a dicarboxylic acid component composing the amorphous polyester resin preferably contains a dicarboxylic acid having a sulfonic acid group, as well as the above-mentioned aliphatic dicarboxylic acid and aromatic dicarboxylic acid. A dicarboxylic acid having the sulfonic acid group is effective since the dicarboxylic acid contributes to the enhancement of the dispersibility of the colorant such as pigment. Moreover, when the dicarboxylic acid has the sulfonic acid group, it is possible to prepare the resin particle dispersion by emulsifying or suspending/dispersing the resin particles into the aqueous medium without using surfactant.

In conversion to tetrahydrofuran (THF)-soluble content, preferably, a weight-average molecular weight of the amorphous polyester resin is 2000 to 60000, and from a viewpoint of enhancing low-temperature fixing properties, more preferably, 3000 to 20000. Here, the weight-average molecular weight is measured by gel permeation chromatography (GPC). Specific device conditions are shown below. A measurement sample is dissolved in tetrahydrofuran at a concentration of 1 mg/ml. Dissolution conditions for the measurement sample are as follows. The measurement sample is poured into tetrahydrofuran, and is sonicated by an ultrasonic disperser at room temperature for 5 minutes. Subsequently, an obtained sample-dissolved solution is filtered by a membrane filter with a pore size of 0.2 μm, and thereafter, 10 μL thereof is injected into the GPC. Specific examples of measurement conditions in the GPC are shown below.

GPC apparatus: HLC-8220 GPC (made by Tosoh Corporation)
Column: TSK gel G2000 HXL (inner diameter 7.8 mmx 30 cm)×3 (made by Tosoh Corporation)
Column temperature: 40° C.
Solvent: tetrahydrofuran
Flow rate: 1.0 ml/min
Concentration of sample: 0.1% (v/w)
Injection amount of sample: 100 μl
Detector: refractive index detector (RI detector)

In measuring the molecular weight of the sample, a molecular weight distribution of the sample is calculated by using a calibration curve measured by using monodisperse polystyrene standard particles. 10 pieces of polystyrene are used for measuring the calibration curve.

From a viewpoint of acquiring fixing characteristics, a mass ratio of the crystalline polyester resin to the amorphous polyester resin in the toner (crystalline polyester resin:amorphous polyester resin) preferably ranges in 2:98 to 60:40, more preferably, 5:95 to 40:60.

A method for producing the above-described amorphous polyester resin is not particularly limited. The amorphous polyester resin can be produced by a publicly known polyester resin polymerization method which reacts an acid component with an alcohol component. Specifically, such a production method can be selected properly from direct polycondensation method, a transesterification method and the like depending on a type of the monomer. A molar ratio of the reacting acid component and the reacting alcohol component (acid component:alcohol component) cannot be uniquely determined since the ratio differs depending reaction conditions and the like. However, the ratio is usually 1:1.

When producing the amorphous polyester resin, preferably, a polymerization temperature is set at 180 to 230° C., and preferably, the pressure inside of a reaction system is reduced according to needs. The acid component and the alcohol component are reacted with each other while removing water and alcohol which are generated by the polymerization from the reaction system. When a monomer is not soluble or not compatible at a reaction temperature, adding a high boiling point solvent as a solubilization agent dissolves such a monomer. Preferably, the high boiling point solvent is evaporated during the polymerization. Moreover, when there is a monomer which is less compatible in a copolymerization reaction, preferably, the monomer which is less compatible is reacted with the acid or the alcohol in advance, and thereafter, the reacted monomer is polymerized together with main components.

Moreover, preferably, the polymerization reaction is performed by adding a catalyst at the time of producing the amorphous polyester resin. As the usable catalyst, for example, a tin compound, a zirconium compound, and a germanium compound are mentioned. Specifically, there are mentioned tetraphenyltin, dibutyltin dichloride, dibutyltin oxide, diphenyltin oxide, zirconium tetrabutoxide, zirconium naphthenate, zirconyl carbonate, zirconyl acetate, zirconyl stearate, zirconyl octylate, germanium oxide, triphenyl phosphite, tris(2,4-di-tert-butylphenyl)phosphite, ethyltriphenyl phosphonium bromide, triethyl amine, and triphenyl amine. Furthermore, from a viewpoint of reducing an emission amount of carbonic acid gas generated by producing the amorphous polyester resin by lowering the polymerization temperature, there can also be used rare earth metal, and Lewis acid such as dodecylbenzene sulfonic acid.

### <Crystalline Polyester Resin>

The toner for use in the present invention contains the crystalline polyester resin as a fixing assistant. In the present invention, the crystalline polyester resin refers to a polyester resin having an apparent endothermic peak in the curve of the differential scanning chromatography (DSC). By containing the crystalline polyester resin, the low-temperature fixing properties can be realized.

The crystalline polyester resin is not particularly limited as long as the crystalline polyester resin concerned is polyester resin having the endothermic peak as described above. For example, in the case where there is a polymer with a structure in which principal chains of the crystalline polyester resin are copolymerized with other components, if resin composed of this polymer exhibits the endothermic peak, then this polymer may be applied as the crystalline polyester resin of the present invention.

As the acid component that composes the crystalline polyester resin, a variety of dicarboxylic acids are mentioned. From a viewpoint of coating or containing therein a releasing agent and preventing separation of the crystalline polyester resin from the amorphous polyester resin that is to form a matrix, among them, aliphatic dicarboxylic acid is preferable, and straight-chain aliphatic dicarboxylic acid is particularly preferable.

As the aliphatic dicarboxylic acid that forms the crystalline polyester resin for use in the present invention, for example, there are mentioned oxalic acid, malonic acid, succinic acid, glutaric acid, adipic acid, pimelic acid, suberic acid, azelaic acid, sebacic acid, 1,9-nonane dicarboxylic acid, 1,10-decane dicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid. Moreover, lower alkyl esters and acid anhydrides of these aliphatic dicarboxylic acids can also be used. Among the above-described aliphatic dicarboxylic acids, adipic acid, fumaric acid, succinic acid, and dodecenyl succinic acid are preferable from a viewpoint of the low-temperature fixing.

Moreover, it is also possible to prepare the crystalline polyester by adding an aromatic dicarboxylic acid to the aliphatic dicarboxylic acid. As the usable aromatic dicarboxylic acid, for example, terephthalic acid, isophthalic acid, and orthophthalic acid are preferable. Loadings of the aromatic dicarboxylic acid are preferably set at 20 mol % or less, more preferably 10 mol % or less, still more preferably mol % or less of the crystalline polyester resin. By setting the loadings of the aromatic dicarboxylic acid at 20 mol % or less, the emulsification at the preparing of the polyester resin can be surely performed. In addition, crystallinity of the polyester resin can be ensured. As described above, the loadings of the aromatic dicarboxylic acid at 20 mol % or less of the crystalline polyester resin are preferable in terms of obtaining image gloss intrinsic to the crystalline polyester resin. Moreover, the above is preferable since there is eliminated an apprehension about a decrease of image retention property, which may be caused by a drop of a melting point.

As an alcohol compound that composes the alcohol component of the crystalline polyester resin, aliphatic diols are preferable, and among them, straight-chain aliphatic diol, in which the number of carbon atoms composing the principal chains ranges from 2 to 22, is more preferable. Moreover, from a viewpoint of availability, sure obtainment of the low-temperature fixing properties, and acquisition of an image having high gloss, particularly preferable is straight-chain aliphatic diol, in which the number of carbon atoms composing the principal chains ranges from 2 to 14. Furthermore, branched aliphatic diol can also be used. In this case, it is preferable that a ratio of the straight-chain aliphatic diol be set higher than a ratio of the branched aliphatic diol in terms of ensuring the crystallinity of the polyester resin. By setting the ratio of the straight-chain aliphatic dial higher, the crystallinity can be ensured, and there occurs no problem of the decrease of the image retention property, which may be caused by the drop of the melting point, and further, effects in stabilization of toner blocking resistance and the low-temperature fixing properties are brought.

By setting the number of carbon atoms composing the principal chain of the aliphatic diol within the range of 2 to 22, polyester resin with such a melting point at which the low-temperature fixing is hindered is not formed even if the aromatic dicarboxylic acid is used in combination, and the polyester resin can be fused sufficiently at the time of the low-temperature fixing. Moreover, a toner image having high gloss can be formed. The toner image is an image formed by using the toner.

As the aliphatic diol, there are mentioned ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol; however, the aliphatic dial is not limited to these. Note that, among these mentioned here, ethylene glycol, 1,4-butanediol, 1,6-hexanediol, 1,9-nonanediol and 1,10-decanediol are preferable.

With regard to the alcohol component composing the crystalline polyester resin, a content of the aliphatic diol component is set preferably at 80 mol % or more of the alcohol component, more preferably at 90 mol % or more. In the alcohol component, diol components other than the aliphatic diol may be contained according to needs. By setting the content of the aliphatic diol component at 80 mol % or more of the alcohol component, effects are brought in realizing the crystallinity of the polyester resin, the high gloss of the formed toner image, and further, the low-temperature fixing properties.

With regard to the crystalline polyester resin for use in the present invention, the melting point thereof is set preferably within a range of 60° C. to 98° C., more preferably within a range of 70° C. to 92° C. By setting the melting point of the crystalline polyester resin within the range of 60° C. to 98° C., there do not occur such problems on the occurrence of the filming and the decrease of the retention property of the toner image after the fixing treatment, which may result from the melting point of the polyester resin. Moreover, problems on image roughening and on the decrease of the gloss, which may be caused by a too high melting point, do not occur, either.

From a viewpoint of ensuring the filming resistance, a weight-average molecular weight of the crystalline polyester is preferably 10000 to 20000, more preferably 15000 to 19000. Here, the weight-average molecular weight refers to the one measured by the gel permeation chromatography (GPC) in a similar way to the weight-average molecular weight of the above-mentioned amorphous polyester resin.

A content of the crystalline polyester resin in the whole of the toner is preferably within a range of 1 to 40 mass %, more preferably within a range of 5 to 30 mass %. By setting the content of the crystalline polyester resin within a range of 1 to 40 mass %, desired low-temperature fixing properties are obtained, and the dispersibility of the colorant is not hindered, either. Moreover, toner crush caused by the crystalline polyester resin does not occur, and the filming does not occur, either.

### <Colorant>

As the colorant, publicly known colorants such as carbon black, a magnetic material, dye and pigment can be arbitrarily used.

As colorant of black, there can be used magnetic powder such as magnetite and ferrite, as well as carbon black such as furnace black and channel black.

As colorants of chromatic colors, there are mentioned pigments such as C.I. Pigment Red 5, C.I. Pigment Red 48:1, C.I. Pigment Red 53:1, C.I. Pigment Red 57:1, C.I. Pigment Red 81:4, C.I. Pigment Red 122, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, C.I. Pigment Yellow 14, C.I. Pigment Yellow 17, C.I. Pigment Yellow 74, C.I. Pigment Yellow 93, C.I. Pigment Yellow 94, C.I. Pigment Yellow 138, C.I. Pigment Yellow 155, C.I. Pigment Yellow 180, C.I. Pigment Yellow 185, C.I. Pigment Orange 31, C.I. Pigment Orange 43, C.I. Pigment Blue 15:3, C.I. Pigment Blue 60, and C.I. Pigment Blue 76. Moreover, there can be mentioned dyes such as C.I. Solvent Red 1, C.I. Solvent Red 49, C.I. Solvent Red 52, C.I. Solvent Red 58, C.I. Solvent Red 68, C.I. Solvent Red 11, C.I. Solvent Red 122, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 69, C.I. Solvent Blue 70, C.I. Solvent Blue 93, and C.I. Solvent Blue 95. Moreover, these may be mixed with one another.

### <External Additive>

From a viewpoint of the filming resistance, as the external additive, it is preferable to add cerium oxide particles, titanate particles, or aliphatic metal salt with a carbon number of 20 to 50, as well as publicly known hydrophobic silica and hydrophobic metal oxide.

### <Releasing Agent>

The releasing agent for use in the present invention is not particularly limited, and a publicly known releasing agent can be used. Specifically, there are mentioned: low molecular weight polyolefins such as polyethylene, polypropylene, and polybutene; synthetic ester wax; plant-derived wax such as carnauba wax, rice wax, candelilla wax, Japan wax, and jojoba oil; mineral/petroleum wax such as montan wax, paraffin wax, microcrystalline wax, and Fischer-Tropsch wax; or denatured things of these.

Among such releasing agents as described above, the synthetic ester wax with a melting point of 70° C. to 95° C. is particularly preferably usable from the viewpoint of preventing the filming. As examples of the above-described synthetic ester wax, there are mentioned behenyl behenate, pentaerythritol tetrabehenate, and tribehenyl citrate. Moreover, the synthetic ester wax such as behenyl behenate, pentaerythritol tetrabehenate, and tribehenyl citrate and the paraffin wax with a melting point of 75 to 100° C. are used in combination, whereby the enhancement of the gloss of the toner image and the enhancement of the filming resistance can be made compatible with each other.

Among such paraffin waxes, when wax with a melting point of 75 to 100° C. is used, offset properties in a high temperature range can be enhanced at any process speed from a low speed range to a high speed range. In addition, in an image forming apparatus using a cleaning blade as cleaning means, good blade cleaning performance can be expressed.

A content of such a releasing agent in the toner is preferably 5 to 20 mass %, more preferably 7 to 13 mass %. If the content is less than 5 mass %, then the offset sometimes occurs in the high temperature range, and if the content exceeds 20 mass %, then the releasing agent tends not to be easily taken into the inside of the toner.

### <Method for Producing Toner>

A description is made below of the production method of the present invention by mentioning a specific example.

(1) Mixing, with an aqueous medium, a resin solution of an organic solvent in which amorphous polyester resin having unsaturated dicarboxylic acid monomer units is dissolved, thereby forming an amorphous polyester resin particle dispersion.

The polyester resin is dissolved into an organic solvent such as ethyl acetate and methylethylketone. The obtained solution is emulsified/dispersed in an aqueous medium by using a disperser. Thereafter, the organic solvent may be removed. Alternatively, a polyester resin particle dispersion may be prepared as disclosed in Japanese Patent Laid-Open Publication No. 2006-337995. That is, the dispersion is prepared by a condensation reaction of multivalent alcohol and multivalent carboxylic acid in liquid droplets formed with strong acid such as dodecylbenzene sulfonic acid in an aqueous medium. In the polyester resin particles, a volume median diameter thereof is preferably 50 to 400 nm, particularly preferably 250 nm to 360 nm. If there is a surplus producing capacity, toner internal additives such as the releasing agent, the colorant and a charge control agent may be contained and dispersed in the polyester resin (solution) in advance of preparing the polyester resin particle dispersion.

Here, the aqueous medium refers to water containing a dispersant such as the surfactant, and less than 50% of organic solvent such as alcohols and ketones may be dissolved in the water.

(2) Adding a radical polymerization initiator to the amorphous polyester resin particle dispersion obtained in (1), and cross-linking the amorphous polyester resin, thereby forming the cross-linked amorphous polyester resin particle dispersion.

As the radical polymerization initiator, a water-soluble radical polymerization initiator is particularly preferable from a viewpoint of production stability. For example, in order to obtain the effects of the present invention, a water-soluble radical polymerization initiator such as persulfate such as potassium persulfate and ammonium persulfate; or a redox initiator combining oxidant such as hydrogen peroxide with a reductant such as ascorbic acid, erythorbic acid and ferrous salt is preferably used. Persulfate is particularly preferably used since the persulfate has high reactivity and is excellent in productivity.

(3) Mixing the cross-linked amorphous polyester resin particle dispersion obtained in (2), the crystalline polyester resin particle dispersion, and a colorant particle dispersion with one another, adding an aggregation agent into the obtained mixed dispersion, and adjusting a temperature of the mixed dispersion, thereby forming toner particles.

The colorant particle dispersion is obtained by dispersing the colorant into an aqueous medium. When preparing this colorant particle dispersion, the dispersion is performed by mechanical energy of a disperser, and the disperser is not particularly limited. There can be used an agitator Clearmix (made by M Technique Co., Ltd.) including a rotor that rotates at a high speed, an ultrasonic disperser, a mechanical homogenizer, Cavitron, Manton-Gaulin, a pressure homogenizer, and the like.

With regard to the colorant particles in the prepared colorant particle dispersion, a volume median diameter thereof is preferably 10 to 300 nm, more preferably 100 to 200 nm, still more preferably 100 to 150 nm. For example, by adjusting a magnitude of the above-mentioned mechanical energy, the volume median diameter can be controlled within the above-described ranges.

As the aggregation agent, for example, there are mentioned aluminum metal salt, alkaline metal salt, alkaline earth metal salt and the like. As alkaline metals of these salts, lithium, potassium, sodium and the like are mentioned. Moreover, as alkaline earth metals of these salts, magnesium, calcium, strontium, barium and the like are mentioned. Among them, potassium, sodium, magnesium, calcium and barium are particularly preferable. As counter ions (negative ions composing salt) of the alkaline metal or the alkaline earth metal, chloride ions, bromide ions, iodide ions, carbonate ions, sulfate ions and the like are mentioned. As the aggregation agent, there is also usable an organic solvent having water solubility, such as alcohol, tetrahydrofuran, and ketone. When the polyester resin is dissolved into the organic solvent thereby preparing the polyester resin particle dispersion, leaving approximately 5 to 20% of the organic solvent in the polyester resin particle can set the loadings of the aggregation agent at an extremely small amount, or can omit the aggregation agent. However, it becomes necessary to remove the solvent after the toner particles are aggregated to a desired particle diameter.

Note that a particle diameter of the toner particles, that is, a volume median diameter D₅₀ is preferably 4.0 to 9.0 μm from a viewpoint of balancing image quality and handling.

The volume median diameter D₅₀ of the toner particles is measured and calculated by an apparatus in which a computer system (made by Beckmann Coulter Co., Ltd.) that installs data processing software “Software V3.51” therein is connected to Coulter Multi-Sizer 3 (made by Beckmann Coulter Co., Ltd.).

A measurement procedure of the volume median diameter D₅₀ of the toner particles is as follows. 0.02 g of the toner is applied to 20 ml of a surfactant solution (a surfactant solution, for example, in which a neutral detergent containing a surfactant component is diluted to ten times by pure water for the purpose of dispersing the toner), and thereafter, ultrasonic dispersion is performed therefor for 1 minute, whereby a toner dispersion is prepared. This toner dispersion is injected by a pipette into a beaker in a sample stand, into which ISOTON II (made by Beckmann Coulter Co., Ltd.) is contained, until a concentration thereof displayed on a measuring instrument becomes 5% to 10%. By setting the toner dispersion within this concentration range, a reproducible measurement value is obtained. In such a measuring machine, the counting number of measured particles is set at 25000, an aperture diameter is set at 100 μm, and a frequency value is calculated by dividing a range of 1 to 30 μm as a measurement range into 256 parts. The volume median diameter is defined as a particle diameter at which integrated volume of the particles from a higher side of the diameter (where the particle diameter is larger) is 50% of the whole particles.

In the case of adding the releasing agent, a dispersion (wax emulsion) of releasing agent particles just needs to be added into the above-described mixed dispersion in (3), and the resin particles, the colorant particles and the releasing agent particles just need to be salted out and aggregated. Alternatively, as mentioned, in (1) or (2), the dispersion of the releasing agent particles may be added, and a dispersion of the resin particles and the releasing agent particles may be prepared in advance, and the aggregation may be performed therefor in a following (4).

(4) Filtering the toner particles from the mixed dispersion, and removing an undesired substance such as the surfactant from the toner particles by cleaning treatment
(5) Performing dying treatment for the toner particles subjected to the cleaning treatment
(6) Adding an external additive to the toner particles subjected to the drying treatment

If needed, an external additive such as hydrophobic silica and metal oxide particles and the toner particles obtained in (5) are dry-mixed with each other.

Note that, in (3), the aggregation agent is added into the mixed dispersion, in which the cross-linked amorphous polyester resin particle dispersion obtained in (2), the crystalline polyester resin particle dispersion and the colorant particle dispersion are mixed with one another, then the temperature of the obtained mixed dispersion is adjusted, whereby the toner particles are formed. However, in the above-described (3), a procedure may be adopted, in which the crystalline polyester resin particle dispersion, the cross-linked amorphous polyester resin particle dispersion obtained in (2), the colorant and further, a non-cross-linked amorphous polyester resin particle dispersion, are added together, then the aggregation agent is added into the obtained mixed dispersion, and the toner particles are formed.

### EXAMPLES

A description is made below of specific examples of the present invention; however, the present invention is not limited to these.

### 1. Synthesis of (Non-Cross-Linked) Amorphous Polyester Resin, Preparation of (Non-Cross-Linked) Amorphous Polyester Resin Particle Dispersion

(1-1) Synthesis of amorphous polyester resin (A1)
Fumaric acid: 4.2 mass parts
Terephthalic acid: 78 mass parts

### (Multivalent Alcohol Monomer)

Propylene oxide (2 mol) adduct of 2,2-bis(4-hydroxyphenyl)propane: 152 mass parts
Ethylene oxide (2 mol) adduct of 2,2-bis(4-hydroxyphenyl)propane: 48 mass parts

Into a reaction container including an agitation device, a nitrogen introduction pipe, a temperature sensor and a rectifying column, there were poured the above-described multivalent carboxylic monomer and multivalent alcohol component. Then, a temperature of a mixture thus obtained was raised to 190° C. for 1 hour. After confirming that the reactant was uniformly agitated, and thereafter, a catalyst Ti(OBu)₄ (0.006 mass % with respect to the total amount of the multivalent carboxylic acid monomer) was poured into the reactant.

Moreover, while evaporating generated water, the temperature of a mixture was raised from 190° C. to 240° C. for 6 hours, and a dehydration condensation reaction was further continued at 240° C. for 6 hours to perform polymerization, whereby (non-cross-linked) amorphous polyester resin (A1) was obtained.

When a resin molecular weight of the obtained amorphous polyester resin (A1) was measured by the GPC, a weight-average molecular weight thereof was 8100.

### (1-2) Preparation of (Non-Cross-Linked) Amorphous Polyester Resin Particle Dispersion (A1)

The resin obtained by the above-described synthesis of the resin was roughly pulverized by a hammer mill, and by using an obtained resultant, a resin particle dispersion was prepared.

Into a reaction container provided with an anchor impeller that gives agitation power, there were added 180 mass parts of methylethylketone and 60 mass parts of IPA, and N₂ was supplied, whereby the air in the container was substituted.

Subsequently, while heating the reaction container to 60° C. by a heating oil bath, 291 mass parts of the amorphous polyester resin (A1) was slowly added, and was dissolved while being agitated.

Subsequently, 20 mass parts of 10% ammonia water was added to a resultant, and thereafter, 1500 mass parts of deionized water was poured into the obtained solution by using a metering pump while agitating the solution. When the solution exhibits a milk-white color and agitation viscosity is decreased, the point of time is defined to be the ending time of the emulsification.

Subsequently, the resin particle dispersion was pumped up from the reaction chamber by using a differential pressure caused by centrifugal force, and was transferred to a reaction vessel. The reaction vessel includes an agitation impeller that forms a wet wall on an inner wall thereof, a reflux device, and a pressure reduction device by a vacuum pump. The resin particle dispersion was agitated under a condition where a temperature of a reaction vessel inner wall temperature is 58° C., and an inner pressure of the reaction vessel is reduced to 8 kPa [abs]. When the resin particle dispersion in the reaction vessel reached 650 mass parts, the reaction was then ended, and the inner pressure of the reaction vessel was turned to a normal pressure, and the resin particle dispersion was cooled to a normal temperature while being agitated. A volume median diameter of the resin particles dispersed in the obtained resin particle dispersion (A1) was 262 nm.

### (1-3) Synthesis of (Non-Cross-Linked) Amorphous Polyester Resin (A2)

4.2 mass parts of the fumaric acid used in the synthesis of the amorphous polyester resin (A1) was changed to 4.7 mass parts of itaconic acid. In a similar way to the synthesis of the amorphous polyester resin (A1) other than the above, amorphous polyester resin (A2) was synthesized. A weight-average molecular weight of the obtained amorphous polyester resin (A2) was 8000.

### (1-4) Preparation of (Non-Cross-Linked) Amorphous Polyester Resin Particle Dispersion (A2)

The resin for use in the preparation of the amorphous polyester resin particle dispersion (A1) was changed to the amorphous polyester resin (A2). In a similar way to the preparation of the amorphous polyester resin particle dispersion (A1) other than the above, an amorphous polyester resin particle dispersion (A2) was prepared. A volume median diameter of the resin particles dispersed in the obtained resin particle dispersion (A2) was 255 nm.

### 2. Preparation of Cross-Linked Polyester Resin Particle Dispersion

(2-1) Preparation of Cross-Linked Polyester Resin Particle dispersion B1

To 2100 mass parts of the “amorphous polyester resin particle dispersion (A1)” obtained above and to 1250 mass parts of ion exchange water, there was added a polymerization initiator solution in which 10.3 mass parts of potassium persulfate was dissolved into 210 mass parts of ion exchange water. A resultant solution was heated and agitated for 2 hours at 80° C., whereby a cross-linking reaction was performed. After the reaction was ended, the solution was cooled down to 28° C., whereby a “cross-linked polyester resin particle dispersion B1” was prepared. The “cross-linked polyester resin particle dispersion B1” was subjected to solid-liquid separation, and a weight-average molecular weight of a tetrahydrofuran-soluble content of the cross-linked polyester resin particle dispersion B1 was measured. Then, the measured weight-average molecular weight was 28700.

Note that the amount of a tetrahydrofuran-insoluble content, that is, a gel content remained on a membrane filter with a pore size of 0.2 μm, was 6.4 mass % with respect to (a solid content of) the cross-linked polyester resin particle B1. When the gel content was analyzed by Solid C13NMR, though it was difficult to perform a quantitative comparison, it was confirmed that a peak of tertiary carbon atom was raised more than that of the solid content of the amorphous polyester resin dispersion (A1).

### (2-2) Preparation of Cross-Linked Polyester Resin Particle Dispersion B2

In the preparation of the above-described cross-linked polyester resin particle dispersion B1, the amorphous polyester resin particle dispersion (A2) was used in place of the amorphous polyester resin particle dispersion (A1). Other than the above, in a similar way to the preparation of the cross-linked polyester resin particle dispersion B1, a cross-linked polyester resin particle dispersion B2 was prepared. The “cross-linked polyester resin particle dispersion B2” was subjected to the solid-liquid separation, and a weight-average molecular weight of a tetrahydrofuran-soluble content of the cross-linked polyester resin particle dispersion B2 was measured. Then, the measured weight-average molecular weight was 30200. Note that, when a tetrahydrofuran-insoluble content was measured in a similar way to the cross-linked polyester resin particle B1, the amount of the tetrahydrofuran-insoluble content was 6.1 mass % with respect to (a solid content of) the cross-linked polyester resin particle B2.

### 3. Preparation of Crystalline Polyester Resin Particle Dispersion (C1)

In the preparation of the above-described amorphous polyester resin particle dispersion (A1), crystalline polyester resin (C1) composed of 1,10-decanediol and sebacic acid was used in place of 291 mass parts of the amorphous polyester resin (A1). Other than the above, in a similar way to the preparation of the amorphous polyester resin particle dispersion (A1), a crystalline polyester resin particle dispersion (C1) was obtained. A volume median diameter of emulsified particles thus obtained was 207 nm.

### 4. Preparation of Cyan Colorant Dispersion

Copper C.I. Pigment Blue 15:3 50 mass parts
Ionic surfactant (sodium dodecylbenzene sulfonate) 5 mass parts
Deionized water 195 mass parts

The above-described materials were mixed and dissolved together, and were dispersed for 10 minutes by a homogenizer (Ultra-Turrax made by IKA Japan K. K.), whereby a cyan colorant dispersion was obtained, in which a median diameter of particles was 150 nm, and a solid content amount was 20 weight %.

### 5. Preparation of Releasing Agent Dispersion

Paraffin wax FNP 92 (melting point: 91° C., made by Nippon Seiro Co., Ltd.) 50 mass parts
Ionic surfactant (sodium dodecylbenzene sulfonate) 5 mass parts
Deionized water 195 mass parts

The above-described materials were heated to 60° C., were sufficiently dispersed by Ultra-Turrax T50 made by IKA Japan K.K., and were thereafter subjected to dispersion treatment by a pressure ejection Gaulin homogenizer, whereby a wax dispersion was obtained, in which a median diameter of particles was 170 nm, and a solid content amount was 20 weight %. By using the materials prepared above, toner particles were produced by an aggregation coalescence method.

### 6. Production of Toner Particles

### (6-1) Production of Toner Particles 1

Amorphous polyester resin particle dispersion (A1) 500 mass parts
Cross-linked polyester resin particle dispersion (B1) 510 mass parts
Crystalline polyester resin particle dispersion (C1) 200 mass parts
Cyan colorant dispersion 100 mass parts
Releasing agent dispersion 150 mass parts
Deionized water 790 mass parts

In a stainless steel-made round-bottom flask, the above-described materials were sufficiently mixed/dispersed by Ultra-Turrax T50. Subsequently, 0.98 mass parts of aluminum sulfate was added to a resultant mixture, and such a dispersing operation was continued by Ultra-Turrax. The flask was heated to 47° C. by a heating oil bath while being agitated. The flask was held at 47° C. for 60 minutes.

Thereafter, pH of the resultant mixture was adjusted to 8.0 by adding 0.5 Mol/L of a sodium hydroxide solution. Thereafter, the stainless steel-made flask was sealed, heated to 90° C. and held for 3 hours while being stirred by using a mechanical stirrer of which a bearing is sealed by a magnetic fluid. After the reaction was ended, the flask was cooled, and the reaction resultant in the flask was filtered. The residue was sufficiently cleaned by deionized water, and was thereafter subjected to the solid-liquid separation by Nutsche suction filtration. The separated residue was further re-dispersed in 5000 mass parts of deionized water at 40° C., was agitated/cleaned at 300 rpm for 15 minutes, and was subjected to the sold-liquid separation. Such cleaning was further repeated five times. Then, when pH of filtrate became 7.01, electrical conductivity thereof became 9.8 μS/cm, and surface tension thereof became 71.1 Nm, the dispersion of the residue was subjected to the solid-liquid separation by the Nutsche suction filtration by using No. 5A filter paper. Subsequently, vacuum drying for an obtained residue was continued at 40° C. for 12 hours, whereby toner particles 1 were obtained.

A volume median diameter D₅₀ of the obtained toner particles 1 was 6.3 μm.

### (6-2) Production of Toner Particles 2

Cross-linked polyester resin particle dispersion (B1) 1360 mass parts
Crystalline polyester resin particle dispersion (C1) 200 mass parts
Cyan colorant dispersion 100 mass parts
Releasing agent dispersion 150 mass parts
Deionized water 440 mass parts

In a stainless steel-made round-bottom flask, the above-described materials were sufficiently mixed/dispersed by Ultra-Turrax T50, and the subsequent operations were performed in a similar way to the example of producing the toner particles 1, whereby toner particles 2 were produced. A volume median diameter D₅₀ of the obtained toner particles 2 was 6.4 μm.

### (6-3) Production of Toner Particles 3

In the example of producing the toner particles 2, the cross-linked polyester resin particle dispersion (B1) was changed to the cross-linked polyester resin particle dispersion (B2). Other than this, in a similar way to the production of the toner particles 2, toner particles 3 were produced. A volume median diameter D₅₀ of the obtained toner particles 3 was 6.3 μm.

### (6-4) Production of Toner Particles 4 (Aspect of Example 1 in Japanese Patent Laid-Open Publication No. 2010-55092)

Amorphous polyester resin particle dispersion (A1) 500 mass parts
Crystalline polyester resin particle dispersion (C1) 200 mass parts
Cyan colorant dispersion 100 mass parts
Releasing agent dispersion 150 mass parts
Deionized water 1000 mass parts

In a stainless steel-made round-bottom flask, the above-described materials were sufficiently mixed/dispersed by Ultra-Turrax T50. Subsequently, to a resultant mixture, 0.98 mass parts of aluminum sulfate was added, and such a dispersing operation was continued by Ultra-Turrax. The flask was heated to 47° C. by a heating oil bath while being agitated. A diameter of a particle in the dispersion was monitored by a Coulter counter until the diameter thereof reached 6.3 μm. Subsequently, a mixture of 300 mass parts of the amorphous polyester resin particle dispersion (A1) and 2.5 mass parts of potassium persulfate was added to the particles at 45° C., and a shell was formed, followed by heating at approximately 50° C. for 2 hours. A volume median diameter of an obtained intermediate body of the toner particles was 8.3 μm. Thereafter, NaOH was added so as to raise pH of reaction slurry to approximately 6.3, and subsequently, approximately 2.0 mass parts of ethylene diamine tetracarboxylic acid (EDTA) was added to stop toner growth. After the growth of the toner particles was stopped, the reaction mixture was heated to 69° C., and pH of the reaction slurry was lowered to approximately 6.2 by using a 0.3 M of HNO₃ solution. Subsequently, this slurry was heated at approximately 90° C. for approximately 2 hours in order to ensure the generated cross links. pH of the reaction slurry was maintained at 6 to 6.3 by adding NaOH thereto. The cleaning and the sold-liquid separation after the end of the reaction were performed in a similar way to the example of producing the toner particles 1.

A volume median diameter D₅₀ of the obtained toner particles 4 was 8.4 μm.

### (6-5) Production of Toner Particles 5

In the toner particles 1, 800 mass parts of the polyester resin particle dispersion A1 was used in place of 500 mass parts of the polyester resin particle dispersion A1 and 510 mass parts of the cross-linked polyester resin particle dispersion B1. The cross-linked polyester resin particle dispersion B1 was not used. Other than the above, in a similar way to the toner particles 1, toner particles 5 were obtained. A volume median diameter D₅₀ of the obtained toner particles 5 was 6.4 μm.

### 7. Evaluation of Gloss Level

Trial production of 10 lots was performed for each type of the toner particles 1 to 5, and gloss levels and variability of the gloss levels were measured in the following procedure.

### <Evaluation Method of Gloss Level>

As an image forming apparatus, a commercially available multi-function printer “bizhub PRO C6501” (made by Konica Minolta Business Technologies, Inc.) was used. Each of the lots of the toners 1 to 5 was put into this multi-function peripheral. A surface temperature of a heating member of a fixing device by a heat roller fixing method was set at 150° C. Under an environment of normal temperature and normal humidity (temperature: 20° C.; humidity: 50% RH), a solid color image in which a toner amount on transfer paper was set at 0.5 mg/cm² was formed on “POD Gloss Coat 128 (128 g/m²)” (made by Oji Paper Co., Ltd.). Note that the gloss level was measured by a gloss level meter “Gloss Meter” (made by Murakami Color Research Laboratory Co., Ltd.) at an incident angle of 75° while taking as a reference a glass surface with a refractive index of 1.567.

For the 10 lots of each of the toners 1 to 5, a maximum value, minimum value and an arithmetic mean value of the gloss levels were measured. When the arithmetic mean value of the gloss levels is in the ranges from 40 to 60 and the difference between the maximum value and minimum value of the gloss levels is 6 or less in the same toner formula, the toner formula is determined as acceptable.

Evaluation results are shown in the Table 1 of the attached drawing.

Note that Table 1 also shows types of the resins composing the respective toners and the like in Examples 1 to 3 and Comparative examples 1 and 2.

From the results in Table 1, it is recognized that, in comparison with Comparative examples 1 and 2, in each of Examples 1 to 3, the mean value of the gloss level is controlled within an appropriate range, and the toner is stable with less variability in the production thereof.

In accordance with the preferred embodiment of the present invention, the radical polymerization initiator is added to the amorphous polyester resin particle dispersion, whereby the cross-linked amorphous polyester resin particle dispersion is formed in advance. Thereafter, the cross-linked amorphous polyester resin particle dispersion and the crystalline polyester resin particle dispersion are mixed and the cross-linked amorphous polyester resin particles and the crystalline polyester resin particles are aggregated with each other, whereby the toner particles are formed. Therefore, a specific surface area of the amorphous polyester resin particle is remarkably more than a specific surface area of intermediate particles of the aggregated toner, the surface at which the amorphous polyester resin particle contacts the polymerization initiator. Therefore, the cross-linking of the particles in the amorphous polyester resin particle dispersion is progressed rapidly, and a degree of cross-linking becomes stable. Hence, the variability of the gloss level of the toner depending on the production lots are suppressed, and it becomes possible to stably produce the toner.

The entire contents of the disclosure including specifications, claims, drawings and an abstract in Japanese Patent Application No. 2010-162723 filed on Jul. 20, 2010 are incorporated herein by reference.

The description has been shown and made above of the variety of typical embodiments; however, the present invention is not limited to these embodiments. Hence, the scope of the present invention is limited only by the following scope of claims.

What is claimed is:

1. A method for producing toner, comprising the following (1) to (3) of:
(1) mixing, with an aqueous medium, a resin solution of an organic solvent in which amorphous polyester resin having unsaturated dicarboxylic acid monomer units is dissolved, and forming an amorphous polyester resin particle dispersion;
(2) adding a radical polymerization initiator to the amorphous polyester resin particle dispersion obtained in the (1), cross-linking the amorphous polyester resin, and forming a cross-linked amorphous polyester resin particle dispersion; and
(3) mixing at least the cross-linked amorphous polyester resin particle dispersion obtained in (2), with a crystalline polyester resin particle dispersion, aggregating cross-linked amorphous polyester resin particles and crystalline polyester resin particles, and forming toner particles.

2. The method for producing toner according to claim 1, wherein, in (3), the cross-linked amorphous polyester resin particle dispersion obtained in (2), the crystalline polyester resin particle dispersion, and further, a non-cross-linked amorphous polyester resin particle dispersion are mixed with one another, the cross-linked amorphous polyester resin particles, the crystalline polyester resin particles and non-cross-linked amorphous polyester resin particles are aggregated with one another, and the toner particles are formed.

3. The method for producing toner according to claim 1, wherein the unsaturated dicarboxylic acid monomer units are 1 mass % or more to 10 mass % or less in a whole of acid monomer units which compose the amorphous polyester resin.

4. The method for producing toner according to claim 1, wherein the unsaturated dicarboxylic acid monomer units are derived from fumaric acid.

5. The method for producing toner according to claim 1, wherein the radical polymerization initiator is a water-soluble radical polymerization initiator.

6. The method for producing toner according to claim 1, wherein the radical polymerization initiator is persulfate.

7. The method for producing toner according to claim 1, wherein the organic solvent is methylethylketone and/or ethyl acetate.

8. The method for producing toner according to claim 1, wherein a volume median diameter of amorphous polyester resin particles in the amorphous polyester resin particle dispersion in (1) is 250 nm to 360 nm.

9. The method for producing toner according to claim 1, wherein the amorphous polyester resin for use in (1) is linear polyester that does not contain a trivalent or more multivalent carboxylic monomer.

10. The method for producing toner according to claim 1, wherein a weight-average molecular weight of the amorphous polyester resin for use in (1) is 3000 to 20000.
